(19) United States
(12) Patent Application Publication
(10) Pub. No.: US 2024/0020664 A1
(43) Pub. Date: Jan. 18, 2024

(54) METHODS AND DEVICES FOR UTILIZING A CRYPTOCURRENCY BACKED DEBIT CARD

(71) Applicant: Signify Holdings, Inc., New York, NY (US)

(72) Inventors: Yoon Kwan Kim, Brooklyn, NY (US); Charles Naut, Brooklyn, NY (US); Farooq Malike, San Antonio, TX (US)

(73) Assignee: Signify Holdings, Inc., New York, NY (US)

(21) Appl. No.: 18/476,121

(22) Filed: Sep. 27, 2023

(51) Int. Cl. G06Q 20/10; G06Q 20/26; G06Q 20/20; G06Q 20/36; G06Q 20/38; G06Q 20/40; G06Q 20/42

(52) U.S. Cl. CPC G06Q 20/105; G06Q 20/26; G06Q 20/20; G06Q 20/3678; G06Q 20/389; G06Q 20/405; G06Q 20/42

(57) ABSTRACT

Methods and systems for conducting a debit card-based transaction using by a user having a crypto-currency account. A user may enter a smart contract between the user and an externally owned account (EOA). Then based on the smart contract an authorizing entity may allow or deny a transaction request from a point-of-sale device to the card processor based on confirmation of the on-chain transaction.

### TECHNICAL FIELD

The present disclosure relates generally to blockchain supported transaction environments, and in particular, relates to system and methods for providing blockchain-based debit cards that draw against crypto tokens for transaction at a point of sale.

### BACKGROUND

Conventionally, debit card utilization is widespread among individuals and entities engaged in modern commerce on a regular basis. A debit card is an electronic payment card allowing charges to be incurred against the cardholder's deposit account denominated in fiat currency, such as a savings account, checking account, or equivalent. Unlike credit cards, which are not linked to cash deposits unless the user maintains a reserve line on their deposit account, a debit card is only functional when the account holder has sufficient funds in the corresponding deposit account.

While payment card usage appears straightforward to the cardholder, involving actions such as swiping, tapping, or inserting their card into a point-of-sale device (POS device) at a merchant, inputting payment card details online for an e-commerce transaction, or presenting card information to the merchant, the underlying process to complete a card-based transaction is a highly intricate, resource-intensive, and complex operation requiring substantial coordination among multiple entities for its success.

For instance, a typical payment card-based transaction necessitates coordination between a cardholder, a merchant, an acquiring bank (the merchant's bank), an issuing bank (the institution that issued the card to the cardholder), the acquiring bank's processor (the entity providing services, software, or devices enabling merchants to accept card payments, e.g., POS devices), and a card network (the entity or entities managing the network processing card-based payments and governing interchange fees).

In a traditional scenario, a debit card must have a fiat currency amount associated with it. Exemplary embodiments allow for utilizing a debit card associated with a crypto-currency network in real time, specifically, exemplary methods do not require a previous conversion of crypto tokens to fiat currency.

### SUMMARY

An object of the invention is to provide a method for conducting a debit card-based transaction using by a user having a crypto-currency account, comprising entering a smart contract, on a crypto currency network, between a user and an externally owned account (EOA), receiving, at one or more processors associated with an authorizing entity, from one or processors associated with a card processor, a request from a point of sale device to approve an amount in fiat currency. Furthermore, the method may comprise forwarding a new transaction request to the crypto-currency network, from the one or more processors associated with the authorizing entity, to execute the smart contract, wherein executing the smart contract comprises transferring a quantity of tokens corresponding to the amount of the fiat currency from the user's wallet to the EOA, initiating a fund transfer and withdrawing, on the crypto-currency network, the quantity of the tokens corresponding to the amount of the fiat currency from the user's wallet to the EOA and updating a ledger on the crypto-currency network, confirming, by one or more processors associated with the authorizing entity, an on-chain transaction corresponding to the transaction request on the blockchain based on the updated ledger on the crypto-currency network, and approving, utilizing the one or more processors associated with the authorizing entity, the request from the point-of-sale device to the card processor based on confirmation of the on-chain transaction.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments of the present disclosure will now be described by way of example in association with the accompanying drawings in which:

FIG. 1 is a block-diagram illustrating multiple components that are provided within debit-card based cryptocurrency transaction environment, consistent with one of more exemplary embodiments of the present disclosure;

FIG. 2 discloses a flowchart for a method for conducting a debit card based transaction using by a user having a crypto-currency account, consistent with one or more exemplary embodiment of the present disclosure; and

FIG. 3 depicts a block diagram of an example computer system in which various of the embodiments described herein may be implemented, consistent with one of more exemplary embodiments of the present disclosure.

### DETAILED DESCRIPTION

Embodiments of the present invention pertain to conducting transactions for the exchange of goods and/or services utilizing debit cards linked with cryptocurrency. While the examples herein may use a specific cryptocurrency for illustration, it should be noted that these examples may apply to any suitable cryptocurrency, including but not limited to Bitcoin, Litecoin, Ethereum, Dash, Ripple, and Monero.

Initially, a user may access a website hosted by an external authorizing entity to establish a cryptocurrency account linked to a payment device, such as a debit card. In an exemplary embodiment, an Authorizing Entity may refer to an entity which may issue a debit card. In an exemplary embodiment, an Authorizing Entity may have an Externally Owned Account (EOA) within an exemplary cryptocurrency network which it may be able to control. As such, an Authorizing Entity (AE) may be able to communicate with card processors or card networks to approve or refuse transactions at a point-of-sale device at an exemplary merchant's based on information related to an exemplary user corresponding to a particular debit card. Furthermore, an authorizing entity may further have a crypto wallet, communication with crypto-exchanges, and ability to communicate a cryptocurrency network, which may allow it to enter smart contracts or make transactions on an exemplary cryptocurrency network.

Accordingly, in an exemplary user may enter a smart contract with an Authorizing Entity to provide it access to its tokens. In an exemplary embodiment, it may be done so by acquisition of an ERC2-20 token. For example, a user may acquire USDC, which is a digital stablecoin pegged to the United States Dollar. In an exemplary embodiment, USDC may be available as an Ethereum ERC-20 token, and on blockchains including Hadera Hasgraph, Algorand, Avalanche, Solana, Stellar, Plygon, and TRON. In an exemplary embodiment, ERC-20 tokens standards allows for fungible tokens on the Ethereum blockchain, that is, ERC-20 tokens allow for functionality as smart contracts that is included within their protocols.

In an exemplary embodiment, a user may hold existing cryptocurrency (e.g., Ethereum) into their wallet. Alternatively, they may hold ERC-20 compliant tokens. In a first exemplary scenario, a user may acquire ERC-20 tokens. Accordingly, once an Authorizing Entity (which may have issued a debit card to a user) receives a request for fiat currency approval from an exemplary card processor, an exemplary authorizing entity may acquire a corresponding amount of cryptocurrency from an exemplary user based on an EOA on-chain associated with an exemplary Authorizing Entity. In a second exemplary scenario, where an exemplary user holds traditional crypto coins, a smart contract may have to be generated or entered between an exemplary Authorizing Entity and a user.

For instance, an exemplary user may present a payment device (e.g., a debit card) at a merchant to initiate a transaction. In an exemplary embodiment, a transaction may be initiated on a website or a Point-of-Sale (POS) device associated with an exemplary merchant. In an exemplary embodiment, an authorization request message may be sent by a POS device, containing the user's payment credentials (e.g., debit card number, payment account number) and specifying the transaction amount in fiat currency, may transmitted to a computer of the authorizing entity following a conventional procedure. Upon receiving an exemplary authorization request message, the exemplary authorizing entity's computer verifies that the payment device mentioned in the request is linked to a user contained within an exemplary database of the authorizing entity. In an exemplary embodiment, an exemplary computing systems associated with an authorizing entity may check information related to a user in an exemplary database, including, for example, a user's cryptocurrency account balance, may calculate the cryptocurrency equivalent of the fiat currency amount based on the current exchange rate, and may be able to request execution of a smart contract, via a cryptocurrency network, to receive a corresponding amount of cryptocurrency in its exemplary wallet.

In an exemplary embodiment, in light of a successful on-chain transaction, an Authorizing Entity may communicate approval to an exemplary merchant. In an exemplary embodiment, a settlement process may later be executed between financial institutions, including the merchant's financial institution and an exemplary Authorizing Entity which issued an exemplary debit card, facilitated by an exemplary payment processing network.

Exemplary methods and systems described enable exemplary users to conduct transactions utilizing debit cards, while making an exemplary transaction process indistinguishable to exemplary merchant's (or places where an exemplary debit card may be used) from a fiat currency transaction. Moreover, these techniques ensure that transactions occur almost in real-time, enhancing the practicality of using cryptocurrency for transactions.

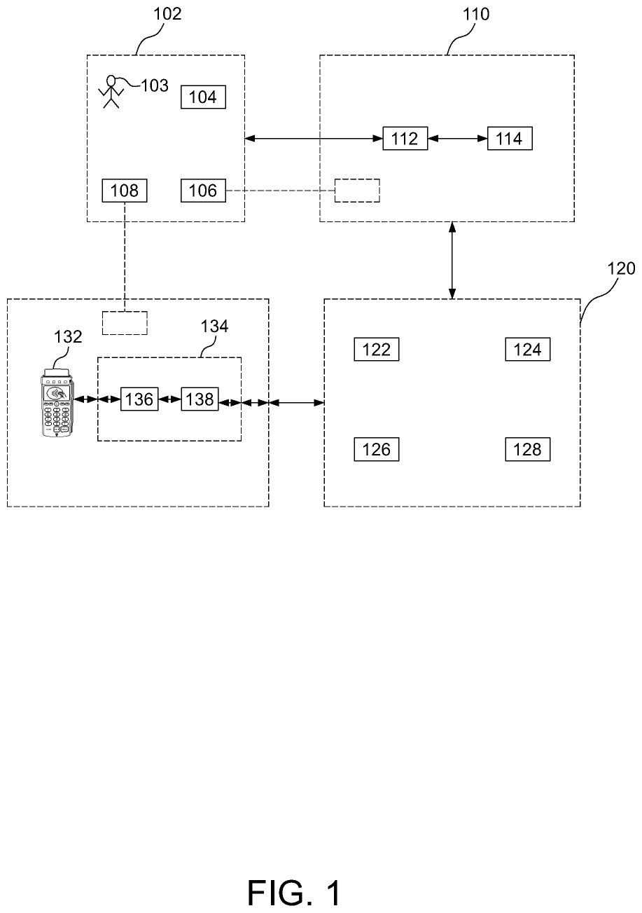

In an exemplary embodiment, FIG. 1 illustrates an exemplary system in which a debit-card based cryptocurrency transaction may be conducted, consistent with one of more exemplary embodiments of the present disclosure.

In detail, FIG. 1 shows a block diagram of a system 100 for performing a transaction utilizing cryptocurrency. The system 100 comprises a user related environment 102, crypto currency network 110, authorizing entity environment 120, and financial institutional environment 130. One of ordinary skill in the art would understand that elements listed within an element may be present in other elements but are illustrated as such for explaining the functionality consistent with exemplary embodiments. Please note that respective user related environments 102, authorizing entity environment 120, and financial institutional environments 130 are just illustrative comprising elements contained within to provide clarity regarding functionality and association between different elements but are not meant to be restrictive to being in physically distinctive spaces.

In an exemplary embodiment, user related environment 102 may include user 103, user device 104 which may be associated with user 103, user wallet 106, and debit card 108.

In an exemplary embodiment, user 103 may refer to an individual or an individual/individuals acting on behalf of an entity. In some embodiments, an exemplary user may be associated with one or more personal accounts (at an exemplary authorizing entity) and/or mobile devices. In an exemplary embodiment, user may also be referred to as a cardholder, account holder, or consumer associated with debit card 108. In an exemplary embodiment, debit card 108 may be issued by an exemplary authorizing entity and may correspond to an exemplary account for an exemplary user, information related to which may be stored by an authorizing entity. In an exemplary embodiment, debit card 108 may be a debit card which may allow a user to conduct a financial transaction, such as to provide payment credentials to a merchant. For example, it may be a card with a magnetic strip or credentials may be uploaded in software form such as utilizing various mechanisms to pay utilizing Bluetooth technology. In an exemplary embodiment, debit card 108 may contain information encoded within it or contained within it to provide information associated with an account (e.g., a payment account and/debit card associated with the account by an authorizing entity). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CW and dCW values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

In an exemplary embodiment, user device 104 may comprise any suitable electronic device that may be transported and operated by user 103, which may also provide remote communication capabilities to an exemplary network. Examples of remote communication capabilities include using a mobile phone (wireless) network, wireless data network (e.g. 3G, 4G or similar networks), Wi-Fi, Wi-Max, or any other communication medium that may provide access to an exemplary network such as the Internet or a private network. Examples of user devices include mobile phones (e.g. cellular phones), PDAs, tablet computers, net books, laptop computers, personal music players, hand-held specialized readers, etc. Further examples of user devices include wearable devices, such as smart watches, fitness bands, ankle bracelets, rings, earrings, etc., as well as automobiles with remote communication capabilities. An exemplary user device, such as, user device 104, may comprise any suitable hardware and software for performing such functions, and may also include multiple devices or components (e.g., when a device has remote access to a network by tethering to another device—i.e., using the other device as a modem—both devices taken together may be considered a single user device). In an exemplary embodiment, user device 104 may have stored thereon on one or more computer storage mediums, an application 104A, which may comprise computer code or other data stored on a computer readable medium (e.g. memory element or secure element) that may be executable by a processor to complete a task. In an exemplary embodiment, user device 104 may allow for a user to conduct transactions with various processors, including allowing a user to enter agreements, access websites, buy cryptocurrency, etc.

In an exemplary embodiment, user wallet 106 may refer to a crypto wallet. In an exemplary embodiment, crypto wallet may refer to a device, physical medium, program or a service which stores the public and/or private keys for cryptocurrency transactions. In an exemplary embodiment, user wallet 106 may be an on-chain digital wallet (and thus would alternatively be part of cryptocurrency network 110) associated a user. In an exemplary embodiment, a cryptocurrency wallet may also offer the functionality of encrypting and/or signing information. In an exemplary embodiment, signing information may result in executing a smart contract. In an exemplary embodiment, keys to any cryptocurrency or tokens that may be stored in user wallet may be acquired by transfer from another individual or entity. Alternatively, user 104 may acquire tokens or cryptocurrency utilizing an exemplary exchange. In an exemplary embodiment, an exemplary exchange may refer to an entity that facilitates exchanges of cryptocurrency and fiat currency between parties. The exchange may manage any suitable number of accounts associated with registered parties. Users that with to sell cryptocurrency may conduct a cryptocurrency transaction to transfer their cryptocurrency to the exchange and the exchange may manage the cryptocurrency on behalf of the user. Users may additionally, or alternatively, transfer fiat currency to the exchange and the exchange may manage the users' fiat currency within the exchange. A user may provide the exchange a “buy request” indicating that the user wishes to purchase a particular amount of cryptocurrency for a particular amount (or within a range of the particular amount) of fiat currency. Users may also provide the exchange a “sell request” indicating that the user wishes to sell cryptocurrency for a particular amount (or within a range of the particular amount) of fiat currency. The exchange may be configured to match a buy requests to a sell request in order to identify a buyer that is willing to purchase cryptocurrency at the fiat currency amount (or within the range) at which the seller is interested in selling. If a match is found, the exchange can facilitate a transfer of the fiat currency from the buyer's account within the exchange to the seller's account within the exchange. The exchange can also facilitate the transfer of the cryptocurrency from the seller's account within the exchange to the buyer's account within the exchange.

In an exemplary, user 103 may be able to use the user device 104 to create and/or manage a cryptocurrency account, interact with smart contracts, etc. In an exemplary embodiment, interacting with smart contracts may entail entering into one, agreeing to one, etc. By way of example, the user 103, utilizing application 104A operating on the user device 104 may access a website hosted by an exemplary server computer (not shown) that may be configured to host a website on behalf of an authorizing entity (e.g., an issued off debit card 108). Through the application 104A (e.g., a wallet application, a browser application, etc.), an exemplary server may provide any suitable number of interfaces to enable the user 103 to create a cryptocurrency account and/or to modify an existing cryptocurrency account.

In an exemplary embodiment, cryptocurrency network 110 may include one or more computers (not illustrated) that participate in maintaining a cryptocurrency ledger 112. Additionally, cryptocurrency network 110 may include an Externally Owned Account 114. As discussed above, user wallet 106 associated with user 103 may be a part of cryptocurrency network 110 as well, that is, user wallet 106 may be on chain. In an exemplary embodiment, a cryptocurrency ledger 112 may comprise a blockchain. In an exemplary embodiment, a blockchain may be a decentralized and distributed digital ledger that may be used to record transactions across many computers so that the record cannot be altered retroactively without the alteration of all subsequent blocks and the collusion of the network. Examples of a cryptocurrency network may include networks of computers that manage any suitable cryptocurrency including, but not limited to, Bitcoin, USDC, Litecoin, Ethereum, Dash, Ripple, and Monero. In an exemplary embodiment, Ethereum network may be utilized.

In an exemplary embodiment, Externally Owned Account (EOA) 114 may comprise an account associated with an exemplary Authorizing Entity, and which may represent an account controlled by a private key and owned by an external (to cryptocurrency network 110) entity, specifically, an exemplary Authorizing Entity. In an exemplary embodiment, EOA 114 may be an Externally Owned Accounted configured to be compatible with an Ethereum Virtual Machine. In an exemplary embodiment, EOA 114 (or exemplary smart contracts within cryptocurrency network 110) may be able to hold either native token from chain, such as Ethereum (ETH), or tokens from ERC-20 smart contract, such as USDC.

In an exemplary embodiment, Authorizing Entity environment 120 may include Authorizing Entity processor 122, Authorizing Entity wallet 124, Authorizing Entity databases 126, and Authorizing Entity fiat account 128.

In an exemplary embodiment Authorizing Entity environment 120 may be associated with an Authorizing Entity. In an exemplary embodiment, an exemplary Authorizing Entity may have issued debit card 108 to user 103 and may have created an associated account at an Authorizing Entity for an exemplary user and corresponding debit card. In an exemplary embodiment, this exemplary account and corresponding debit card may allow for withdrawals or transactions based on a user's cryptocurrency holdings.

In an exemplary embodiment, Authorizing Entity processor 122 may comprises of one or more processors that are configured to manage all functionalities needed for operations of an Authorizing Entity. In an exemplary AE processor 122 may allow for interactions with cryptocurrency network 110, communicate external devices, execute internal codebase, access databases, access other websites and SAAS services. Additionally, in an exemplary embodiment, AE processor 122 may allow a user representing an AE or an automated system to access data, use third-party crypto exchanges to convert cryptocurrency to fiat currency and vice-versa.

In an exemplary embodiment, AE wallet 124 may not be necessary due to presence of EOA 114 which may be able to send and receive cryptocurrency (such as ETH) and interact with smart contracts.

In an exemplary embodiment, Authorizing Entity wallet 124 may refer to a local crypto wallet associated with an exemplary Authorizing Entity. In functionality, it may be similar to user wallet 106. In an exemplary embodiment, AE wallet 124 may contain keys associated with tokens or cryptocurrencies for an Authorizing Entity. These may be received from various exemplary users or various crypto exchanges to which an exemplary Authorizing Entity may interact with utilizing AE processor 122. Additionally, in an exemplary embodiment, AE wallet 124 may be able to hold tokens that may be retrieved from EOA 114.

In an exemplary embodiment, Authorizing Entity databases 126 may refer to one or more exemplary databases which may contain information related to an exemplary Authorizing Entity. In an exemplary embodiment, exemplary databases may be used to store information related to various user accounts, their corresponding debit cards, including any smart contracts or corresponding crypto wallets for the exemplary users. In an exemplary embodiment, databases may include information needed to verify debit cards and furthermore. In an exemplary embodiment, exemplary databases may store further information related to funds available for each user, history of all funds associated with such user, exchange rates between various cryptocurrencies and fiat currency, information related to fiat holdings of the Authorizing Entity, information needed to authenticate, communicate, and interact with any crypto exchanges or exemplary financial institutions. In an exemplary embodiment, AE databases 126 may additionally include information related to EOA 114 including its holdings, how to access, and code to access EOA 114.

In an exemplary embodiment, AE fiat account 128 may be one or more accounts associated with Authorizing Entity that may be fiat currency accounts. In an exemplary embodiment, they may be held at various banking institutions, may be held internally (at the Authorizing Entity if its a bank or bank-related authority), or may be held at various financial services entities (such as exemplary card processors such as card processor 138). In an exemplary embodiment, an Authorizing Entity may utilize Authorizing Entity processor 122 to move fiat currency between one or more fiat currency accounts. Furthermore, an Authorizing Entity may utilize Authorizing Entity processor 122 to hold fiat currency in one or more fiat currency accounts based on cryptocurrency or tokens. These tokens may be converted utilizing external exchanges or internally based on exchange rates.

In an exemplary embodiment, an exemplary Authorizing Entity (and its associated infrastructure such as AE processors 122) may interact with an exemplary merchant utilizing an exemplary financial institutional environment 130.

In an exemplary financial institutional environment 130 may include a point-of-sale (POS) device 132, card transaction network 134 which may comprise a card network 136 and card processor 138.

In an exemplary embodiment, POS device 132 may be associated with an exemplary merchant (not shown). In an exemplary embodiment, POS device 132 may refer to a point-of-sale device which may be used to process transactions by retail customers.

In an exemplary embodiment card transaction network 134 may refer to an environment which may receive a request for approval of a transaction by an exemplary merchant and is able to interact and provide a response from an exemplary authorizing entity, that is, an exemplary entity which may have issued an exemplary debit card, such as, an exemplary authorizing entity issuing debit card 108. In an exemplary embodiment card transaction network may further comprise a card network 136 and card processor 138. In an exemplary embodiment, card network 136 may include various networks which integrate exemplary merchants with exemplary banks, such as, Visa®, Master®, Amex®, Discover®, etc, who may in turn pass this information to card processor 138 to seek authorization from an exemplary EOA. In an exemplary embodiment, card network 136 may allow coordinating and governing various communications between various entities and elements, including various financial institutions which are required in confirming a transaction between an exemplary issuing bank and an exemplary merchant.

In an exemplary embodiment card processor 138 may refer to infrastructure and technology related to an exemplary payment service provider, such as Stripe®, and includes all elements needed to complete an exemplary transaction.

In an exemplary embodiment, user device 104, cryptocurrency network 108, debit card 108, POS device 132, AE processors 122, and all other elements included within system 100 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. In an exemplary embodiment, messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

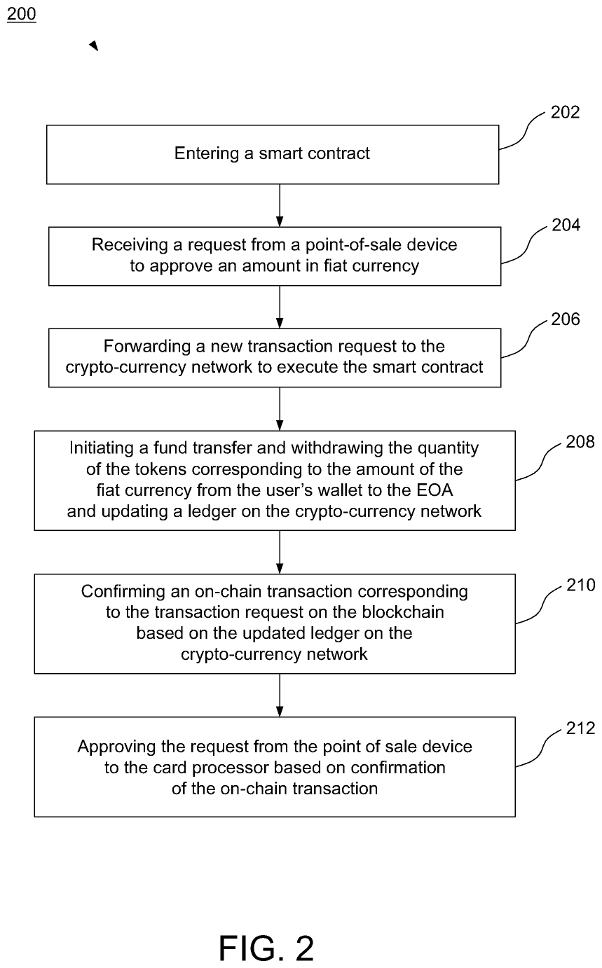

FIG. 2 discloses a flowchart for a method for conducting a debit card-based transaction using by a user having a crypto-currency account, consistent with one or more exemplary embodiment of the present disclosure. In an exemplary embodiment, method 200 of FIG. 2 may be understood in the context of elements of system 100 provided in FIG. 1.

In an exemplary embodiment, method 200 may comprise of step 202 which may comprise of entering a smart contract.

In an exemplary embodiment, entering a smart contract may comprise acquiring an Ethereum Request-for-Comments #20 (ERC-20) token allowing an Authorizing Entity to receive a maximum number of tokens associated with the user to an Authorizing Entity wallet associated with the Authoring Entity. In an exemplary embodiment, an exemplary Authorizing Entity may have an externally owned account (EOA) 114 on cryptocurrency network 120. In an exemplary embodiment, an exemplary user may allow Authorizing Entity's EOA to withdraw a limited among of token from their wallet by using “approve” function in ERC-20. In an exemplary embodiment, this may entail one or more of ERC-20 tokens such as USDC, Tether USD, Shiba Inu, Binance USD, etc.

In another exemplary embodiment, entering a smart contract may comprise generating the smart contract, on the crypto-currency network, allowing cryptocurrency network 110 to transfer a maximum number of tokens from a user's wallet to an Authorizing Entity wallet 124 associated with the Authorizing Entity.

In an exemplary embodiment, generating the smart contract may further comprise of accessing terms of the agreement of the smart contract, utilizing a user device, then inputting acquiescence to the agreement utilizing the user device, and recording the smart contract on a ledger on the crypto-currency network.

In an exemplary embodiment, user device 104 may be utilized to enter into an exemplary smart contract, whether by acquisition of a ERC-20 token or entering a specific exemplary smart contract complying with terms as defined above.

In an exemplary embodiment, step 204 may comprise of receiving, at one or more processors associated with an authorizing entity, from one or processors associated with a card processor, a request from a point-of-sale device to approve an amount in fiat currency. In detail this may comprise, receiving, at AE processor 122, from one or processors (not illustrated) associated with card processor 138, a request from a point-of-sale device 132 to approve an amount in fiat currency. In an exemplary embodiment, card processor 138 may request EA processor 122 approval for a transaction on behalf of an exemplary merchant where an exemplary POS device, for example, POS device 132 may be located.

For illustrative purposes, in an exemplary scenario, when user 103 inserts, taps, slides, or otherwise provides their debit card 108 to an exemplary merchant via POS device 132, an exemplary merchant (not shown) or merchant's processor collects information related to debit card 108 and then passes that debit card 108 on to the card network 136 (e.g., Visa®, Master®, Amex®, Discover®, etc.) who may in turn pass this information to card processor 138 to seek authorization from Authorizing Entity. Accordingly, on behalf of Authorizing Entity, AE processor 122 may then send authorization results to card network 136, who then sends the authorization results to an exemplary merchant (or merchant's processor) and/or merchant's POS device 132.

In detail, a user 103 may present his/her debit card 108 to an exemplary merchant (not shown) for payment, for example, by either inserting, sliding, or tapping his/her debit card 108 into, through, or on a reading zone of a POS device 132, or may present information related to their debit card 108 to an exemplary merchant in numerous ways, such as presenting a digital wallet, presenting a QR code, inputting the payment card number (particularly for online purchasing), RF transmissions, Bluetooth transmissions, smartphone based card transmissions, and any other form. In an exemplary embodiment, POS device 132 may acquire debit card 108 details as user 103 presents debit card 108 to POS device 132. After acquiring debit card 108 details, POS device 132 may send one or more such details to an exemplary acquiring bank (or an exemplary acquiring bank's one or more processors). In an exemplary embodiment, an exemplary acquiring bank may be a bank associated with POS device 132 allowing for an exemplary merchant to receive payments. In an exemplary embodiment, acquiring bank may be a bank where an exemplary merchant (associated with a specific POS device) may hold an account, that is, a bank account where deposits and/or withdrawals may be made.

In an exemplary embodiment, exemplary acquiring bank may transmit one or more debit card 108 details to the card network 136. In an exemplary embodiment, card network 136 may request payment authorization from Authorizing Entity by sending a request to Authorizing Entity processors 122. In general, the payment authorization request that card network 136 sends to Authorizing Entity environment 120 includes one or more debit card 108 details such as, e.g., payment card number, payment card expiration date, billing address (for address verification system validation), payment card security code (e.g., CVV), and/or payment amount. These details may be obtained when user 103 presents his/her debit card 108 to an exemplary merchant.

Upon receiving the debit card 108 details from card network 136, AE processors 122 may verify the validity of user 103 debit card 108 using fraud protection tools such as the address verification service and/or card security codes such as CVV, CVV2, CVC2, CID, etc. In an exemplary embodiment, exemplary AE processors 122 may validate the debit card 108 number, check the amount of available funds, match the billing address to the one on file and validates CVV number. Additionally, AE processors 122 may determine an accounts associated with debit card 108.

In an exemplary embodiment, step 206 may comprise of forwarding a new transaction request to the crypto-currency network, from the one or more processors associated with the authorizing entity, to execute the smart contract, wherein executing the smart contract comprises transferring a quantity of tokens corresponding to the amount of the fiat currency from the user's wallet to the EOA. In detail, this may entail forwarding a new transaction request to the crypto-currency network 110, from AE processors 122, to execute the smart contract, wherein executing the smart contract comprises transferring a quantity of tokens corresponding to the amount of the fiat currency from the user's wallet 106 to EOA 114.

In an exemplary embodiment, AE processors 122 may receive an exemplary request from card processor 138 based on a transaction request at POS device 132. Thereafter, it may be configured to (based on software encoded within memory/databases of AE environment 120) to conduct step 208. Accordingly, AE processors 122 may forward a new transaction request to crypto currency network 110 based on a transaction request received through card processor 138.

In an exemplary embodiment, step 208 may comprise of initiating a fund transfer and withdrawing, on the crypto-currency network, the quantity of the tokens corresponding to the amount of the fiat currency from the user's wallet to the EOA and updating a ledger on the crypto-currency network. In detail, this may entail initiating a fund transfer and withdrawing, on crypto-currency network 110, the quantity of the tokens corresponding to the amount of the fiat currency from the user's wallet 106 to EOA 114 and updating ledger 112 on crypto-currency network 110.

In further detail, in an exemplary embodiment, AE Processor 122 may initiate a fund transfer on-chain, that is conduct the exchange that was enabled in step 202. In an exemplary embodiment, a fund transfer on-chain may be initiated using Ehters.js lib and infura. In an exemplary embodiment, Ethers.js lib may refer to a JavaScript library that is used in off chain codebase. In an exemplary embodiment, using it enables off chain code to communicate with blockchain such as reading account balance and transfer assets to another account. In an exemplary embodiment, off chain codebase may be stored within AE Environment 120. In an exemplary embodiment, in order for ethers js to work with blockchain, it needs node provider like Infura. IN an exemplary embodiment, Infra runs nodes that is part of blockchain so it can do read/write operation. Programmer can enter Infura credential to ethers.js, pay Infura for read/write operations.

In an exemplary embodiment, exemplary withdrawing am amount may be performed utilizing “transferForm” function in ERC-20. In an exemplary embodiment, one or more computers within cryptocurrency network 110 may execute the “transferFrom” function. Accordingly, by execution of exemplary smart contracts, tokens are transferred or the right to have them transferred is provided to an exemplary EOA associated with an authorizing entity, such as EOA 116 and authorizing entity associated with AE processors 122.

In an exemplary embodiment, updating a ledger on the crypto-currency network may refer to one or more computers within cryptocurrency network 110 updating a ledger, such as cryptocurrency ledger 112.

In an exemplary embodiment, step 210 may comprise confirming, by one or more processors associated with the Authorizing Entity, an on-chain transaction corresponding to the transaction request on the blockchain based on the updated ledger on the crypto-currency network.

In an exemplary embodiment, one more processors associated with an Authorizing Entity, such as AE processors 126, may determine that a transaction has occurred or in exemplary embodiments, that a transaction will occur based on a smart contract or an Externally Owned Account, and therefore, update information related to a particular user and corresponding AE account on AE databases 126. This may include, amount of corresponding tokens committed to Authorizing Entity, for example, based on token stored at EOA 116 or based on smart contracts. Accordingly, EOA processors 122 may continue to approve or deny transactions requests based on information included within AE databases 126.

In an exemplary embodiment, step 212 may comprise approving, utilizing the one or more processors associated with the authorizing entity, the request from the point of sale device to the card processor based on confirmation of the on-chain transaction. In detail, this may entail approving, utilizing AE processors 122, the request from the point of sale device 132 to the card processor 138 based on confirmation of the on-chain transaction.

In an exemplary embodiment, in response to confirmation of an on-chain transaction, AE processors 122 may provide a decision to an exemplary merchant via card processor 138 and card processor 136.

Specifically, in an exemplary embodiment, an exemplary authorization result, generated by EOA processors 126, may include a message that responds to an authorization request. In an exemplary embodiment, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that an exemplary AE processor 126 may return in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

Once authorized, user 103 may then confirm the transaction, for example, by signing a confirmation receipt printed by POS device 132.

In an exemplary embodiment, approvals from AE processors 122 may be sent on data related to EOA 116 and specific users. In such exemplary instances, settlements between user wallet 106 and EOA 116 may occur on a periodical basis, that is, daily, weekly, monthly, or another specified amount of time. In an exemplary embodiment, they may occur when a certain transaction threshold is determined by AE processors 122 based on authorizing entity set parameters (which may be stored within AE databases 126). Accordingly, in an exemplary embodiment, transfer of ERC-20 tokens related to multiple transactions may happen concurrently saving “gas” within crytpocurrency network 110.

In an exemplary embodiment, payment settlements between an exemplary merchant and exemplary Authorizing Entity may occur at the end of a given time. For example, payment settlement may occur at the end of the given time (e.g. the end of the day), accordingly an exemplary merchant sends the batch of approved authorizations to an exemplary acquiring bank (or acquiring bank's acquiring processor). Thereafter, an exemplary acquiring bank (or acquiring bank's acquiring processor) may route the batched information to card network 134 for settlement. In an example, AE Fiat Accounts 128 may be utilized to settled payments. In an exemplary embodiment, an exemplary fiat currency account maybe setup with an exemplary card processor 138.

In an exemplary embodiment, card network 136 may forward each approved transaction to card processor 138 (which may hold an account associated to an exemplary EOA or may be able to access or request funds from an exemplary OA) for each transaction in the batch. Usually within 24 to 48 hours of the transaction, card processor 138 may withhold an interchange fee and then transfers the remaining funds to card network 136. In an exemplary embodiment, card network 136 may then distribute funds to an exemplary acquiring bank associate with an exemplary merchant. In an exemplary embodiment, an exemplary acquiring bank may then then disperse received funds into an exemplary merchant's account after deducting any of its own fees. Therefore, within Authorizing Entity environment 120, AE processors 122, may post transaction information to user 103 account. In an exemplary embodiment, information related to user 103 may be updated within AE databases 126 based on any transaction. In an exemplary embodiment, user 103 may receive information regarding transactions and balances through various means, including account information access via user device 104 connecting to AE processors 122, or via any statements received via electronic or regular mail.

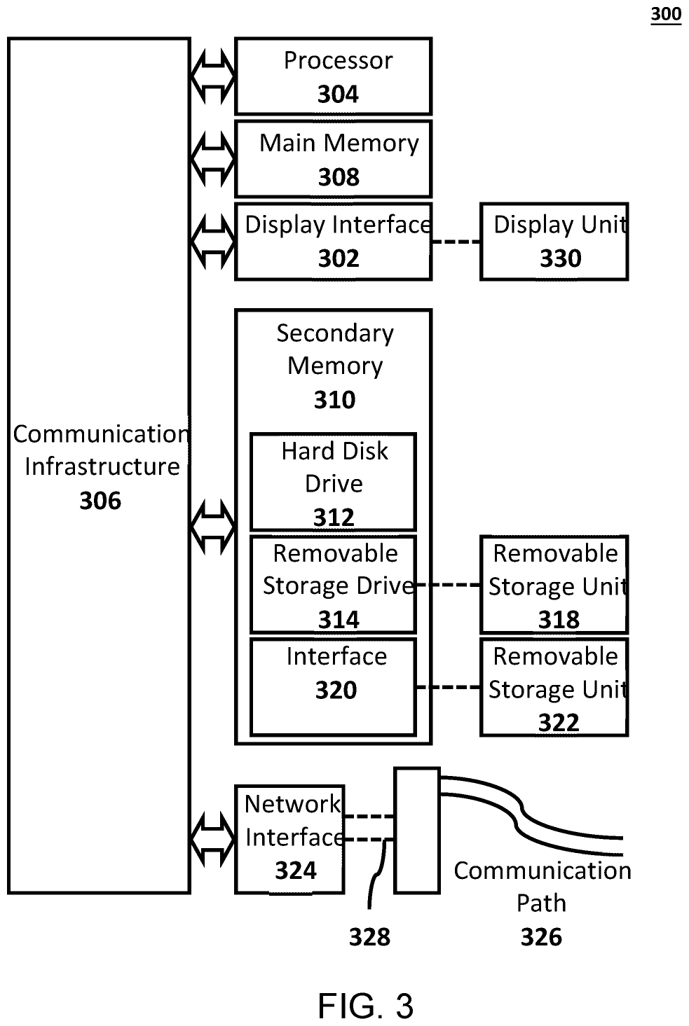

FIG. 3 depicts a block diagram of an example computer system 300 in which various of the embodiments described herein may be implemented. In an exemplary embodiment, system 300 may represent any exemplary computer utilized within system 100, including but not limited to, within cryptocurrency network 110, within elements of AE environment 120, and within various elements of financial institutions environment 130. The computer system 300 includes a bus 302 or other communication mechanism for communicating information, one or more hardware processors 304 coupled with bus 302 for processing information. Hardware processor(s) 304 may be, for example, one or more general purpose microprocessors.

The computer system 300 also includes a main memory 306, such as a random access memory (RAM), cache and/or other dynamic storage devices, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

The computer system 300 further includes a read only memory (ROM) 308 or other static storage device coupled to bus 302 for storing static information and instructions for processor 304. A storage device 310, such as a magnetic disk, optical disk, or USB thumb drive (Flash drive), etc., is provided and coupled to bus 302 for storing information and instructions. For enhanced security, in some embodiments storage at a UNode is embodied in ROM only.

The computer system 300 may be coupled via bus 302 to a display 312, such as a liquid crystal display (LCD) (or touch screen), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. In some embodiments, the same direction information and command selections as cursor control may be implemented via receiving touches on a touch screen without a cursor (e.g., via a touch enabled smartphone).

The computing system 300 may include a user interface component to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Other embodiments incorporating various modifications and alterations may be used in the design and manufacture of the apparatus consistent with exemplary embodiments of the present disclosure without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “front”, “back”, “vertical”, “horizontal”, “up”, “down”, and “side-to-side” are used in a relative sense to the normal orientation of the apparatus.

What is claimed:

1. A method for conducting a debit card-based transaction using by a user having a crypto-currency account, comprising:
entering a smart contract, on a crypto currency network, between a user and an externally owned account (EOA);
receiving, at one or more processors associated with an authorizing entity, from one or processors associated with a card processor, a request from a point of sale device to approve an amount in fiat currency.
forwarding a new transaction request to the crypto-currency network, from the one or more processors associated with the authorizing entity, to execute the smart contract, wherein executing the smart contract comprises transferring a quantity of tokens corresponding to the amount of the fiat currency from the user's wallet to the EOA;
initiating a fund transfer and withdrawing, on the crypto-currency network, the quantity of the tokens corresponding to the amount of the fiat currency from the user's wallet to the EOA and updating a ledger on the crypto-currency network;
confirming, by one or more processors associated with the authorizing entity, an on-chain transaction corresponding to the transaction request on the blockchain based on the updated ledger on the crypto-currency network; and
approving, utilizing the one or more processors associated with the authorizing entity, the request from the point-of-sale device to the card processor based on confirmation of the on-chain transaction.

2. The method of claim 1, entering the smart contract comprises:
acquiring an Ethereum Request-for-Comments #20 (ERC-20) token allowing the externally owned account (EOA) to receive a maximum number of tokens associated with the user to the EOA.

3. The method of claim 3, entering the smart contract comprises:
generating the smart contract, on the crypto-currency network, allowing the transfer of a maximum number of tokens from a user's wallet to an authorizing entity wallet associated with the authorizing entity.

4. The method of claim 3, wherein generating the smart contract comprises:
accessing terms of the agreement of the smart contract, utilizing a user device;
inputting acquiescence to the agreement utilizing the user device; and
recording the smart contract on a ledger on the crypto-currency network.
